(19) United States
(12) Patent Application Publication
(10) Pub. No.: US 2007/0102947 A1
(43) Pub. Date: May 10, 2007

(54) Expandable rear storage vehicle

(76) Inventor: Guangzhen Zhou, San Jose, CA (US)

Correspondence Address: S. Alex Liao;Attorney At Law, Suite 302, 28 N. First St., San Jose, CA, 95113, US

(21) Appl. No.: 11/268,226

(22) Filed: Nov. 7, 2005

(51) Int. Cl. B60P 3/34

(52) U.S. Cl. 296/26.08

(57) ABSTRACT

The present invention relates to a vehicle having a extendable and retractable rear storage space, comprising a compartment for housing people or objects, said compartment having a rear opening and a rear extendable and retractable enclosure portion movably attached to the rear opening of said compartment and covering said rear opening, Said rear enclosure portion further comprises a housing having a front opening and rear opening, a frame, and a rear door, a locking means for securely locking said housing in a desired position for additional storage need, said front opening of said housing securely, extendably, and retractably attached to said rear opening of said compartment, said frame securely attached to said rear opening of said housing, said rear door securely and movably attached to said frame, whereby said housing can be extended outwardly and locked by said locking means in a desired and secure position for an additional storage need; whereby when there is no need of additional storage space, said housing can be retracted closer to said rear opening of said compartment. An extendable and retractable rear bumper is attached to the bottom of said compartment. Said rear bumper can be extendable and retractable in unison with said housing of said rear enclosure.

### BACKGROUND OF THE INVENTION

1. Field of Invention

This invention relates generally in the field of vehicles having expandable rear storage space for additional storage needs. The invention utilizes an extendable and retractable rear housing and rear bumper to expand the rear storage space when needed.

2. Description of the Prior Art

Automobiles become an indispensable transportation tool in our daily life. Consumers of automobiles demand versatility in automobiles with respects to the capacity of passengers and the capacity of storage space. However, automobile manufacturers are mindful that the size of a vehicle has to be within a certain range in order to control the manufacturing costs of the vehicle and the fuel economy of the vehicle.

There has always been a competing interest or dilemma between increasing passenger capacity and storage space in an automobile. For example, if a third row of seats has to be installed and used in a van or sports utility vehicle, the storage space in the back of the vehicle will be dramatically reduced in the current automobile manufacturing. Yet, the additional storage space is not always needed in most of the vehicle use unless a group of people takes three rows of seat in the vehicle while having a lot of luggage. It would have been impractical to build a vehicle with a large amount of fixed storage space, which will definitely increase the costs of the vehicle and fuel consumption.

### SUMMARY OF THE INVENTION

It is therefore the main object of this invention to provide a vehicle having an expandable and retractable rear storage space.

It is another object of the invention to provide a vehicle having an expandable and retractable rear housing used for an additional storage need.

It is yet another object of the invention to provide a rear bumper expandable and retractable in unison with said rear housing.

In summary, these objects can be achieved in a vehicle comprising a compartment for housing people or objects, said compartment having a rear opening and a rear extendable and retractable enclosure portion movably attached to the rear opening of said compartment and covering said rear opening,

Said rear enclosure portion further comprises a housing having a front opening and rear opening, a frame, and a rear door, a locking means for securely locking said housing in a desired position for an additional storage need, said front opening of said housing securely, extentably, and retractably attached to said rear opening of said compartment, said frame securely attached to said rear opening of said housing, said rear door securely and movably attached to said frame, whereby said housing can be extended outwardly and locked by said locking means in a desired and secure position for an additional storage need; whereby when there is no need of additional storage space, said housing can be retracted closer to said rear opening of said compartment.

An extendable and retractable rear bumper is attached to the bottom of said compartment. Said rear bumper can be extendable and retractable in unison with said housing of said rear enclosure.

### BRIEF DESCRIPTION OF THE DRAWINGS

The following drawings are presented for a better understanding of the invention and other objects and features thereof. The following detailed description is to be read in conjunction with the following drawings:

FIG. 1 is a side rear review of a vehicle with the rear door in an open position and with the rear housing and bumper in a retracted position.

FIG. 2 is side rear review of a vehicle with the extendable rear housing and bumper in an extended position and with the rear door in an open position.

FIG. 3 is a rear view of a vehicle with both of the rear housing and bumper in a retracted position and with the rear door in an open position.

FIG. 4 is a rear view of a vehicle with the rear housing and the rear in an extended position and with the rear door in an open position.

FIG. 5 is a view of the bottom of the vehicle showing the rear bumper in an extended position.

FIG. 6 is a side view of the rear bumper support with the lock securing the rear bumper in an extended position.

FIG. 7 is a partial view of the connection between the rear door and the frame.

FIG. 8 is a rear partial view of the support means for the support bar of the frame and the rear housing.

### DESCRIPTION OF PREFERRED EMBODIMENTS

The automobile industry has over 70 years of manufacturing history. The technology and skills in the industry are very sophisticated and advanced in the modern era. A person reasonably skilled in the industry will readily understand the following embodiment and make the vehicle according to the disclosure below.

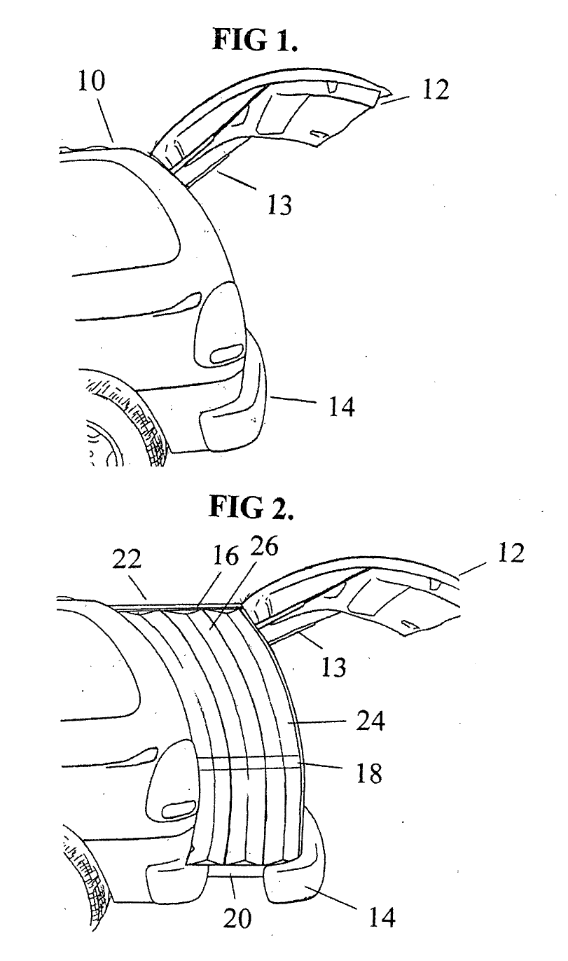

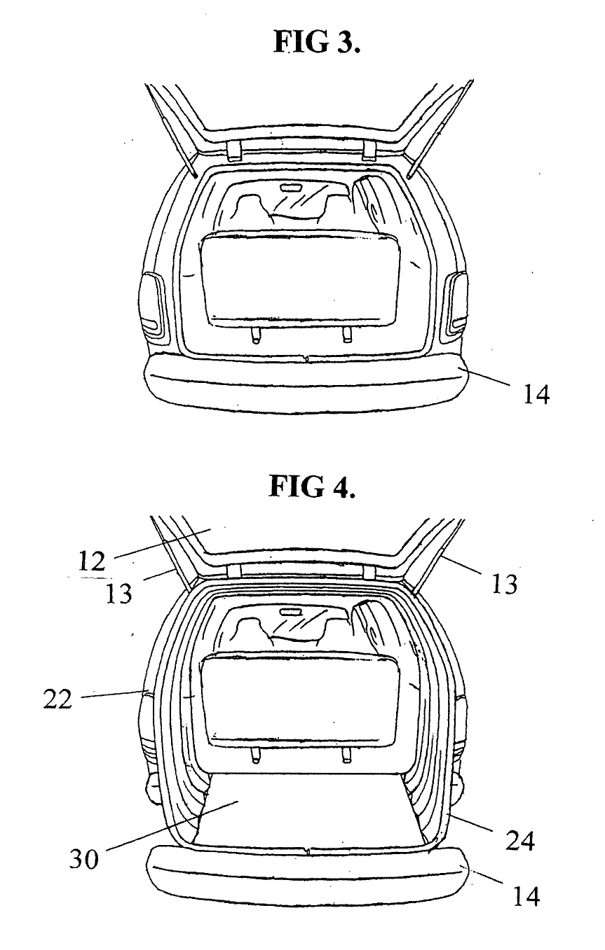

The present invention describes a vehicle having a rear extendable and retractable storage housing. Referring to FIG. 1, a side view of a rear end of a vehicle 10 is shown. The vehicle 10 has a rear door 12, a rear bumper 14 in a retracted position.

Referring to FIG. 2, the review of the vehicle shows the rear housing 22 in an extended position. Preferably, the rear housing 22 is retractably attached to the top and each side of the vehicle 10 through support bars 16 and 18, respectively. Preferably, a frame 24 is securely attached to rear bumper 14. The rear bumper 14 is securely attached the frame 24 and a support bar 20 on each side of the vehicle. The support bar 20 is movably attached to the bottom of the vehicle 10. The housing enclosure 26 can be made of canvas or any collapsible and water-repelling materials.

Referring to FIG. 4, the door 10 is movably attached to support hinges 13. Preferably, some rigid material is used for the additional storage space 30 inside the rear housing 22.

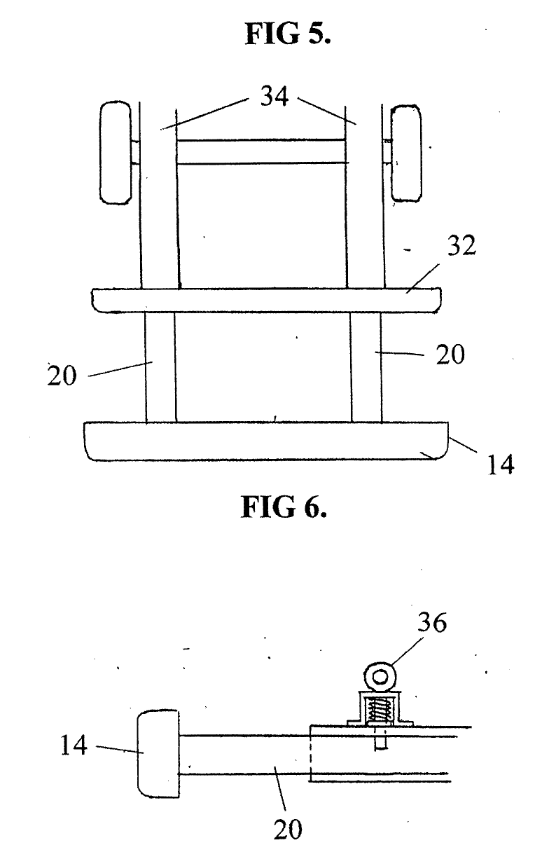

Referring to FIG. 5, a track 34 each receives movable support bar 20. A cross bar 32 may receive the rear bumper 14 in a retracted position. FIG. 6 shows a spring-loaded lock 36 attached on the track 34. There are plurality holes on support bar 20 where the lock 36 can lock through the holes at a desire extended position of the bar 20.

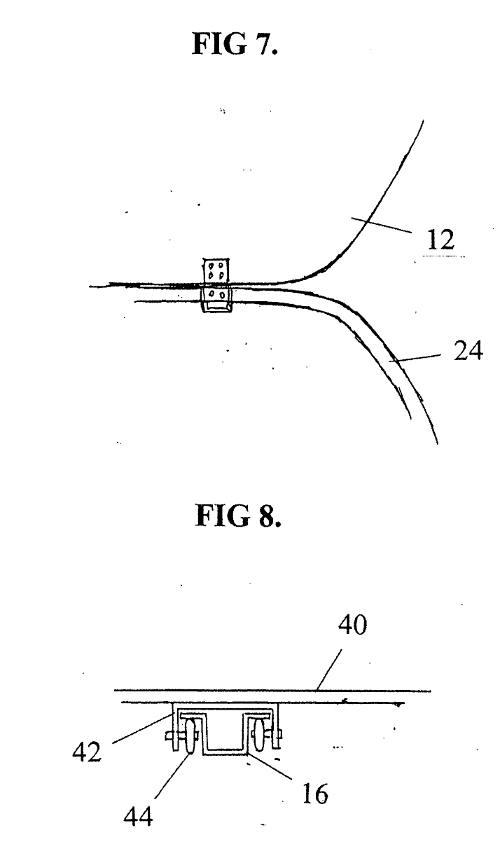

Referring to FIG. 7, the door 12 is pivotably attached to the frame 24. Referring to FIG. 8, a track 42 is attached to the top 40 of the vehicle 10 to receive movable support bar 16. The frame 24 is securely attached to the bar 16. A pair of wheel 44 are attached to the track 42 to facilitate the movement of the bar 16. Preferably, plurality of holes (not shown) can be made in both the bar 16 and the track 42 and a cross pin (not shown) can be placed through the respective holes in the bar 16 and track 42 for the purpose of securely the bar 16 in a desired extended position.

It is therefore to be understood that the present invention is not limited to the embodiments described above, but encompasses any and all embodiments within the scope of the following claims.

I claim:

1. A vehicle having an expandable rear storage space comprising:
a compartment for housing people or objects having a front, a top, a right side, a left side, a bottom, and a rear extendable and retractable enclosure portion, said top, right side, left side, and bottom portion defining an rear opening portion, said rear enclosure portion movably attached to said compartment at said rear opening;
at least three wheels mounted exteriorly on said bottom of said compartment, whereby said vehicle is evenly and securely supported by said wheels;
a motorized means for driving said wheels;
a steering means to steer said wheels;
a braking means to brake said wheels;
an extendable rear bumper mounted on said bottom portion at said rear opening.

2. A vehicle having an expandable rear storage space according to claim 1, said rear enclosure portion further comprising
a housing having a front opening and rear opening;
a frame, and a rear door;
a locking means for securely locking said housing in a desired position for additional storage need;
said front opening of said housing securely, extentably, and retractably attached to said rear opening of said compartment, said frame securely attached to said rear opening of said housing, said rear door securely and movably attached to said frame, whereby said housing can be expanded outwardly and locked by said locking means in a desired and secure position for an additional storage need; whereby when there is no need of additional storage space, said housing can be retracted closer to said rear opening of said compartment.

3. A vehicle having an expandable rear storage space according to claim 1, wherein said rear bumper can be outwardly extended in unison with said housing extended outwardly and said rear bumper is locked in a secured position when extended in unison with said housing for an additional storage need.

4. A vehicle having an expandable rear storage according to claim 2, wherein said frame is further reinforced by a plurality of metal bars slidably and securely attached inside a plurality of metal tracks securely attached to said compartment.

5. A vehicle having an expandable rear storage according to claim 4, wherein said frame is made of metal or alloy.
